(19) United States
(12) Patent Application Publication
(10) Pub. No.: US 2026/0274712 A1
(43) Pub. Date: Sep. 17, 2026

(54) METHOD FOR ADSORBING IODINE

(71) Applicant: Mitsubishi Gas Chemical Company, Inc., Chiyoda-ku, Tokyo (JP)

(72) Inventor: Kentaro KATAOKA, Niigata-shi, Niigata (JP)

(21) Appl. No.: 19/167,769

(22) PCT Filed: Feb. 28, 2024
(86) PCT No.: PCT/JP2024/007224

§ 371 Date: Sep. 22, 2025

(30) Foreign Application Priority Data
Mar. 27, 2023 (JP) 2023-049447

(51) Int. Cl. C02F 1/28; C02F 1/42; C02F 1/76; C02F 101/12; C02F 103/36

(52) U.S. Cl. CPC C02F 1/285; C02F 1/42; C02F 1/76; C02F 2101/12; C02F 2103/365; C02F 2305/02

(57) ABSTRACT

According to the present invention, a method for adsorbing iodine using an adsorption apparatus that contains an adsorbent inside and that has two or more adsorption beds having a supply port and a discharge port connected in series can be provided, wherein the method for adsorbing iodine comprises a step in which an oxidizing agent is added to a liquid that contains iodine which is then passed through a first adsorption bed disposed at a most upstream location, and a step in which the liquid that has passed through the first adsorption bed is passed through one or more adsorption beds disposed downstream from the first adsorption bed and more oxidizing agent is added before passage through any of these one or more adsorption beds.

### TECHNICAL FIELD

The present invention relates to a method for adsorbing iodine from an iodine-containing liquid such as brine water associated with natural gas.

### BACKGROUND ART

Blowing-out and adsorption processes are known as industrial processes for producing iodine from iodine-rich brine water.

In the blowing-out process, chlorine or sodium hypochlorite is used as an oxidizing agent to oxidize iodide ions in brine water to release iodine. The free iodine is then passed along with a large volume of air to an absorption tower, where it is concentrated, and thereafter purified.

On the other hand, in the adsorption process, chlorine or sodium hypochlorite is used as an oxidizing agent to oxidize iodide ions in brine water to release iodine. The free iodine or polyiodide ions formed from the free iodine and iodide ions are separated by adsorption using an adsorbent, and thereafter desorbed and purified.

As the adsorption process, the ion-exchange resin method, the activated carbon method, etc. are known, depending on the type of adsorbent (see, for example, Patent literature 1).

In the ion-exchange resin method, a strongly basic ion-exchange resin with high adsorption efficiency for polyiodine ions is suitably used as an adsorbent.

In the activated carbon method, activated carbon with high adsorption efficiency for free iodine is used as an adsorbent.

In this adsorption process, if the amount of oxidizing agent added to the treated solution is small, iodide ions remain, which are not easily adsorbed, resulting in a decrease in adsorption efficiency. On the other hand, if the amount of oxidizing agent added to the treated solution is large, free iodide is oxidized to form iodate ions, which are not easily adsorbed, resulting in a decrease in adsorption efficiency.

For the adsorption process, fluidized, fixed, and moving bed systems are known, depending on the type of bed.

The fluidized bed system is more suitable for iodine recovery from iodine-rich brine water than the fixed and moving bed systems because it prevents flow reduction and pressure increase caused by the accumulation of suspended substances in the treated solution.

However, since this fluidized bed system generates a circulating flow that flows upward in the center of the fluidized bed and downward near the wall, the adsorption efficiency is reduced and a large amount of adsorbent is required.

In order to solve this problem of low adsorption efficiency, a method of providing a multistage system in an adsorption tower by installing partitions in the adsorption tower has been proposed.

In this multistage adsorption tower, the location of the oxidizing agent supplied to the treated solution was conventionally on the upstream side of the multistage adsorption tower, i.e., the oxidizing agent was fed only at the inlet of the first adsorption bed. Although this multistage adsorption tower solved the problem of low adsorption efficiency to some extent, further improvement of the adsorption rate was required.

### CITATION LIST

### Patent Literature

Patent literature 1: Japanese Unexamined Patent Application Publication No. 2018-8274

### SUMMARY OF INVENTION

### Technical Problem

The objective of the present invention is to provide a method for adsorbing iodine with excellent adsorption efficiency.

### Solution to Problem

After diligent study to solve the above problem, the present inventors found that the adsorption efficiency can be significantly improved by feeding the oxidizing agent not only at the inlet of the first adsorption bed but also at the inlets of the second and subsequent adsorption beds, which led to the present invention.

Thus, the present invention is as follows.
<1> A method for adsorbing iodine using an adsorption apparatus that contains an adsorbent inside and that has two or more adsorption beds each having a feed port and a discharge port connected in series, the method comprising the steps of:
   adding an oxidizing agent to an iodine-containing liquid and passing it through a first adsorption bed disposed at the upstream end; and
   when passing the liquid that has passed through the first adsorption bed through one or more adsorption beds disposed downstream of the first adsorption bed, further adding an oxidizing agent before passing the liquid through any of the one or more adsorption beds.
<2> The method according to <1> above, comprising the step of adding an acid to the iodine-containing liquid before or simultaneously with the addition of the oxidizing agent.
<3> The method according to <2> above, wherein the acid is sulfuric acid.
<4> The method according to any one of <1>-<3> above, wherein the pH of the iodine-containing liquid before passing through the first adsorption bed is 5-7.5.
<5> The method according to any one of <1>-<4> above, wherein the pH of the iodine-containing liquid after the further addition of the oxidizing agent is 5-7.5.
<6> The method according to any one of <1>-<5> above, wherein the number of the adsorption beds is any of 3-5, and an oxidizing agent is further added before the iodine-containing liquid is passed through any of the third to fifth adsorption beds.
<7> The method according to any one of <1>-<5> above, wherein the number of the adsorption beds is any of 3-5, and an oxidizing agent is further added before the iodine-containing liquid is passed through each of the third to fifth adsorption beds.
<8> The method according to any one of <1>-<7> above, wherein the adsorption bed is a fluidized bed.
<9> The method according to any one of <1>-<8> above, wherein the adsorbent is a strongly basic ion-exchange resin.
<10> The method according to any one of <1>-<9> above, wherein the iodine-containing liquid is brine water associated with natural gas.
<11> The method according to any one of <1>-<10> above, wherein the oxidizing agent is chlorine or sodium hypochlorite.
<12> The method according to any one of <1>-<11> above, wherein the oxidation-reduction potential of the iodine-containing liquid before passing through the first adsorption bed is 500-600 mV.
<13> The method according to any one of <1>-<12> above, wherein the oxidation-reduction potential of the iodine-containing liquid after the further addition of the oxidizing agent is 500-600 mV.

### Advantageous Effects of Invention

According to the present invention, in an iodine adsorption apparatus having two or more adsorption beds connected in series, iodine can be adsorbed efficiently because the concentration of free iodine or polyiodine ions, which are easily adsorbed on the adsorption beds, in the treated solution fed to the two or more adsorption beds increases.

### BRIEF DESCRIPTION OF DRAWINGS

FIG. 1 A schematic diagram illustrating a method for adsorbing iodine according to one embodiment of the present invention.

FIG. 2 A schematic diagram illustrating a method for adsorbing iodine according to a conventional technique.

FIG. 3 A schematic diagram illustrating a method for adsorbing iodine in Example 1.

FIG. 4 A schematic diagram illustrating a method for adsorbing iodine in Example 1.

FIG. 5 A schematic diagram illustrating a method for adsorbing iodine in Example 1.

FIG. 6 A schematic diagram illustrating a method for adsorbing iodine in Example 1.

FIG. 7 A schematic diagram illustrating a method for adsorbing iodine in Comparative example 1.

FIG. 8 A schematic diagram illustrating a method for adsorbing iodine in Comparative example 1.

FIG. 9 A schematic diagram illustrating a method for adsorbing iodine in Comparative example 1.

FIG. 10 A schematic diagram illustrating a method for adsorbing iodine in Comparative example 1.

### DESCRIPTION OF EMBODIMENTS

Hereinafter, a method for adsorbing iodine of the present invention is specifically described. The materials and configurations described below are not intended to limit the present invention, and they may be modified in various ways within the scope of the present invention. Herein, when a range of numerical values is indicated with “-”, it includes the numerical values at both ends of the range.

The present invention is a method for adsorbing iodine using an adsorption apparatus that contains an adsorbent inside and that has two or more adsorption beds each having a feed port and a discharge port connected in series, the method comprising the steps of:
adding an oxidizing agent to an iodine-containing liquid and passing it through a first adsorption bed disposed at the upstream end; and
when passing the liquid that has passed through the first adsorption bed through one or more adsorption beds disposed downstream of the first adsorption bed, further adding an oxidizing agent before passing the liquid through any of the one or more adsorption beds.

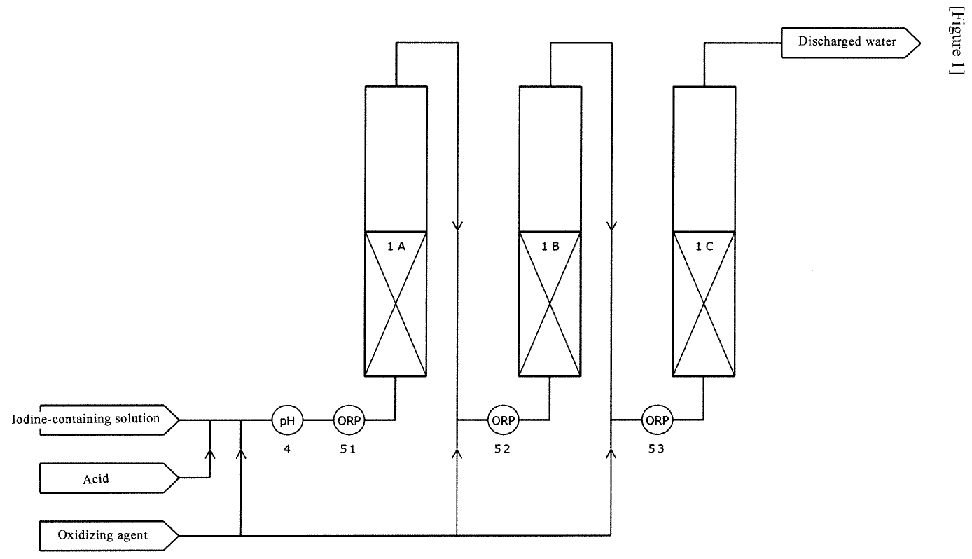

An example of the method for adsorbing iodine of the present invention is described with reference to FIG. 1.

In FIG. 1, an adsorption apparatus having three adsorption beds is used. There should be two or more adsorption beds, and the preferred number of adsorption beds is 3-5. Note that the number of adsorption beds can also be 6 or more and 10 or less, depending on the application.

In FIG. 1, a first adsorption bed 1A, a second adsorption bed 1, and a third adsorption bed 1C are connected in series, with a feed port upstream of each adsorption bed and a discharge port downstream of each adsorption bed. Each adsorption bed contains an adsorbent inside.

A preferred example of the adsorbent is a strongly basic ion-exchange resin in terms of efficient adsorption of free iodine or polyiodine ions. Specific examples of the strongly basic ion-exchange resin preferably include DIAION SA10DL (DIAION is a registered trademark, and the same applies hereinafter), DIAION NSA100, and DIAION UBA100 manufactured by Mitsubishi Chemical Corporation, AMBERLITE IRA402BL (AMBERLITE is a registered trademark) and AMBERJET 4002 (AMBERJET is a registered trademark) manufactured by ORGANO CORPORATION, and particularly preferably include DIAION SA10DL and DIAION NSA100.

An iodine-containing liquid (hereinafter also referred to as “iodine-containing solution”) to which an acid and an oxidizing agent have been added and which is adjusted to a predetermined pH and a predetermined oxidation-reduction potential is fed at the feed port of the first adsorption bed 1A. The acid can be added before or simultaneously with the addition of the oxidizing agent, but it is preferable to add the acid before the addition of the oxidizing agent because iodic acid is easily formed in the basic state.

It is not necessary to add the acid before the addition of the oxidizing agent if the pH of the iodine-containing solution used as the raw material or the pH of the iodine-containing solution after the addition of the oxidizing agent is neutral to acidic.

When the acid is added to the iodine-containing solution before or simultaneously with the addition of the oxidizing agent, specific examples of the acid preferably include sulfuric acid, hydrochloric acid, and nitric acid, and particularly preferably include sulfuric acid.

According to the present invention, the pH of the iodine-containing solution before passing through the first adsorption bed 1A is preferably 5-7.5, and more preferably 6-7.2.

The pH of the iodine-containing solution after further addition of the oxidizing agent (i.e., the iodine-containing solution before passing through any of one or more adsorption beds disposed downstream of the first adsorption bed 1A) is preferably 5-7.5, and more preferably 6-7.2.

The adsorption apparatus shown in FIG. 1 is provided with a pH measurement unit 4 and an oxidation-reduction potential measurement unit 51 upstream of the feed port of the first adsorption bed 1A, so that the pH and the oxidation-reduction potential of the iodine-containing solution before it is fed to the first adsorption bed 1A can be measured. The pH measurement unit 4 and the oxidation-reduction potential measurement unit 51 are not necessarily required, and it is also acceptable to collect the iodine-containing solution at the same location as the measurement units and measure the pH and the oxidation-reduction potential of the collected solution.

The oxidation-reduction potential of the iodine-containing solution before passing through the first adsorption bed 1A is preferably 500-600 mV, and more preferably 530-580 mV.

The oxidation-reduction potential of the iodine-containing solution after further addition of the oxidizing agent (i.e., the iodine-containing solution before passing through any of one or more adsorption beds disposed downstream of the first adsorption bed 1A) is preferably 500-600 mV, and more preferably 530-580 mV.

Specific examples of the oxidizing agent preferably include chlorine, sodium hypochlorite, chloric acid, and hydrogen peroxide, and particularly preferably include chlorine in terms of cost and sodium hypochlorite in terms of safety.

The iodine-containing solution fed to the first adsorption bed 1A passes through the adsorbent in the first adsorption bed 1A and is discharged from the discharge port of the first adsorption bed 1A. An additional oxidizing agent is added to the discharged iodine-containing solution and the resultant is fed at the feed port of the second adsorption bed 1B. The adsorption apparatus shown in FIG. 1 is provided with an oxidation-reduction potential measurement unit 52 upstream of the feed port of the second adsorption bed 1B, so that the oxidation-reduction potential of the iodine-containing solution before it is fed to the second adsorption bed 1B can be measured. The oxidation-reduction potential measurement unit 52 is not necessarily required, and it is also acceptable to collect the iodine-containing solution at the same location as the measurement unit and measure the oxidation-reduction potential of the collected solution.

Similarly, the iodine-containing solution fed to the second adsorption bed 1B passes through the adsorbent in the second adsorption bed 1B and is discharged from the discharge port of the second adsorption bed 1B. An additional oxidizing agent is added to the discharged iodine-containing solution and the resultant is fed at the feed port of the third adsorption bed 1C. The adsorption apparatus shown in FIG. 1 is provided with an oxidation-reduction potential measurement unit 53 upstream of the feed port of the third adsorption bed 1C, so that the oxidation-reduction potential of the iodine-containing solution before it is fed to the third adsorption bed 1C can be measured. The oxidation-reduction potential measurement unit 53 is not necessarily required, and it is also acceptable to collect the iodine-containing solution at the same location as the measurement unit and measure the oxidation-reduction potential of the collected solution.

Finally, the iodine-containing solution fed to the third adsorption bed 1C passes through the adsorbent in the third adsorption bed 1C and is discharged from the discharge port of the third adsorption bed 1C.

The amount of the oxidizing agent added before feeding to the first adsorption bed 1A is preferably adjusted so that the oxidation-reduction potential of the iodine-containing solution fed to the first adsorption bed 1A is 500-600 mV. The amount of the additional oxidizing agent added before feeding to the second adsorption bed 1B and the subsequent bed is preferably adjusted so that the oxidation-reduction potential of the iodine-containing solution fed to each of the second adsorption bed 1B and the third adsorption bed 1C is 500-600 mV.

In one preferred embodiment of the present invention, brine water associated with natural gas, oilfield brine water discharged from underground oil fields, etc., wastewater containing iodide ions, or the like can be used as the iodine-containing solution, but brine water associated with natural gas is particularly preferred.

The following is an exemplary process flow using brine water as the iodine-containing solution, sodium hypochlorite as the oxidizing agent, and an ion-exchange resin as the adsorbent. In the following flow, “Iₓ” represents polyiodine ions, and x is an odd number greater than or equal to 3. In addition, “R—Cl” represents a chloride ion-adsorbed ion-exchange resin, “R—Iₓ” represents a polyiodide ion-adsorbed ion-exchange resin, and “R—I” represents an iodide ion-adsorbed ion-exchange resin.

### Process Flow of Ion-Exchange Resin Method

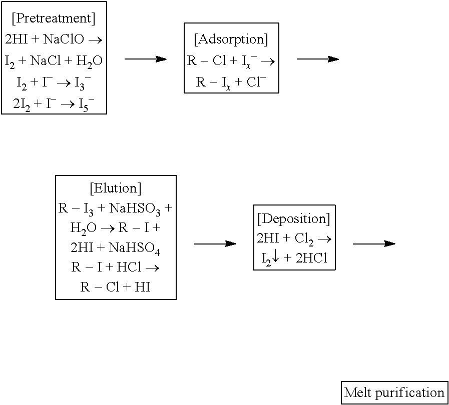

As described above, the number of adsorption beds in the adsorption apparatus used in the present invention is preferably any of 3-5. It is not necessary to add an additional oxidizing agent to the iodine-containing solution before passing the iodine-containing solution through each of the adsorption beds, but an additional oxidizing agent may be added to the iodine-containing solution before passing the iodine-containing solution through any of the adsorption beds.

As an example, a case where three adsorption beds are used is described. In an aspect shown in FIG. 1, an additional oxidizing agent is added before feeding the iodine-containing solution to each of the second and third adsorption beds 1B and 1C, but the addition of an additional oxidizing agent before feeding to the second adsorption bed 1B may be omitted, and an additional oxidizing agent may be added only before feeding to the third adsorption bed 1C. Alternatively, the addition of an additional oxidizing agent before feeding to the third adsorption bed 1C may be omitted, and an additional oxidizing agent may be added only before feeding to the second adsorption bed 1B.

Similarly, when the number of adsorption beds is 4 or 5, it is not necessary to add an additional oxidizing agent to the iodine-containing solution before passing the iodine-containing solution through each of the second and subsequent adsorption beds, but an additional oxidizing agent can be added to the iodine-containing solution before passing the iodine-containing solution through any one or more of the second and subsequent adsorption beds. However, from the viewpoint of efficient iodine adsorption, it is preferable to add an additional oxidizing agent to the iodine-containing solution before passing the iodine-containing solution through each of the second and subsequent adsorption beds.

In one preferred embodiment of the present invention, the adsorption bed in the adsorption apparatus is preferably a fluidized bed from the viewpoint of preventing deposition of suspended substances on the adsorption bed and preventing an increase in the differential pressure in the adsorption bed.

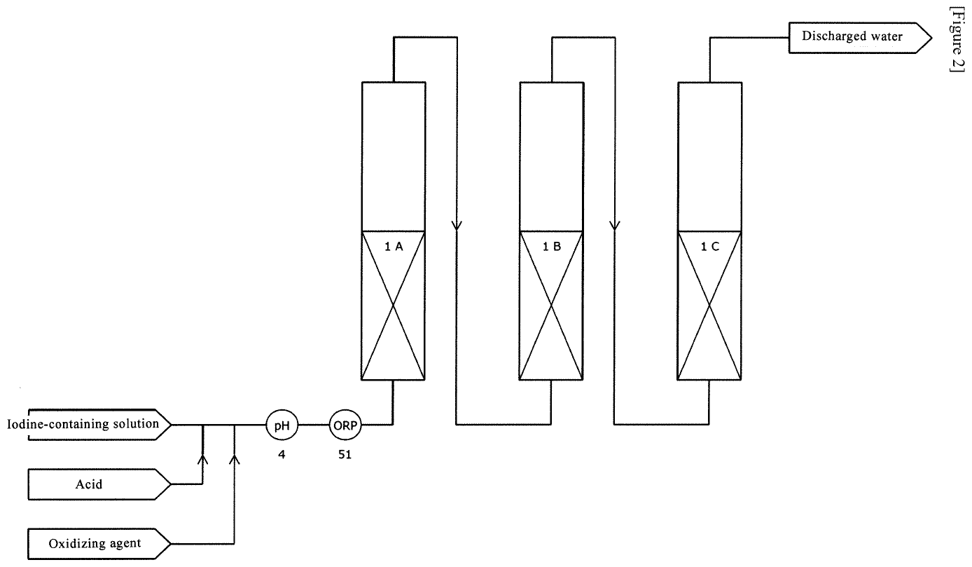

Next, a method for adsorbing iodine according to a conventional technique is described with reference to FIG. 2.

In the conventional method, as shown in FIG. 2, an oxidizing agent is added to the iodine-containing solution only before the iodine-containing solution is fed at the feed port of the first adsorption bed 1A. Accordingly, unlike the present invention, no additional oxidizing agent is added to the iodine-containing solution discharged from the discharge port of the first adsorption bed 1A. Similarly, no additional oxidizing agent is added to the iodine-containing solution discharged from the discharge port of the second adsorption bed 1B.

In the conventional method, the iodine adsorption property (I₂/I− ratio) decreases as the iodine-containing solution passes through the adsorption beds, causing the adsorption rate to deteriorate. In order to solve this problem, the present inventors have succeeded in maintaining the iodine adsorption property (I₂/I− ratio) and improving the adsorption rate by adding an additional oxidizing agent before feeding the iodine-containing solution to each adsorption bed.

### EXAMPLES

Hereinafter, the embodiment is described in more detail by way of examples, although the embodiment is not limited to these examples.

### Example 1

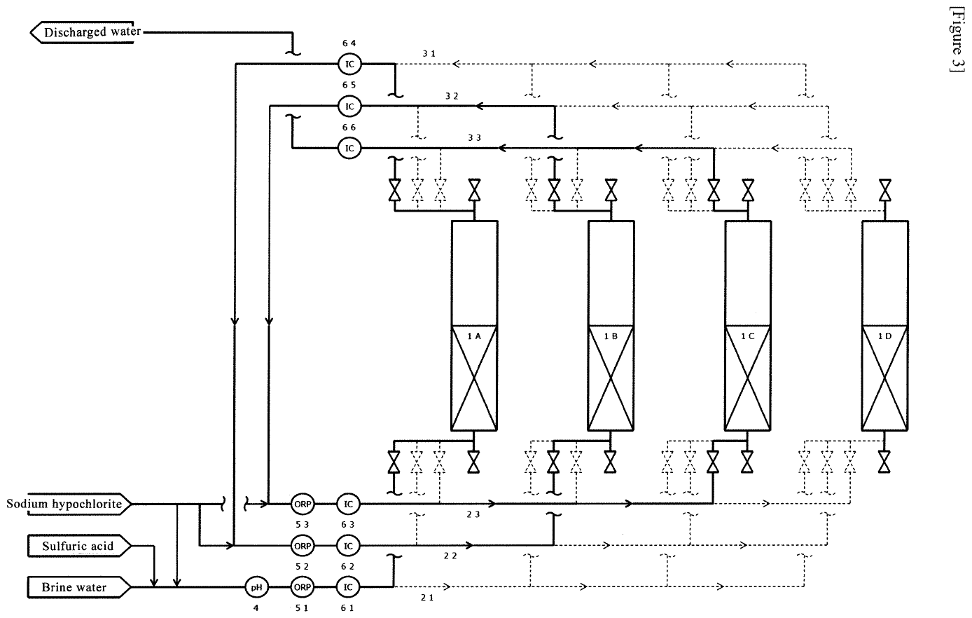

FIGS. 3-6 are schematic diagrams illustrating a method for adsorbing iodine in Example 1. An aspect of Example 1 is described with reference to these figures.

### <Test Method>

In Example 1, four cylindrical tubes made of clear polyvinyl chloride with an inner diameter of 79 mm were used, and these four tubes were designated as a first adsorption bed 1A, a second adsorption bed 1B, a third adsorption bed 1C, and a fourth adsorption bed 1D, respectively.

The first adsorption bed 1A, the second adsorption bed 1B, and the third adsorption bed 1C were packed with a strongly basic ion-exchange resin (product name: SA10DL) manufactured by Mitsubishi Chemical Corporation at a volume of 1.3 L/bed.

The adsorption beds were connected in the order of the first adsorption bed 1A, the second adsorption bed 1B, and the third adsorption bed 1C, from the upstream end to the downstream end. Hereinafter, a case where the adsorption beds are connected in the order of the first adsorption bed 1A, the second adsorption bed 1B, and the third adsorption bed 1C to adsorb iodine in brine water on each adsorption bed is referred to as “ABC adsorption”.

Brine water as a solution to be treated was fed at a location upstream of the first adsorption bed 1A. The flow rate of the brine water was set to 97.5 L per hour. The iodine concentration of the brine water was 45.7 mg/L. After that, the brine water was fed continuously.

An aqueous sulfuric acid solution with a concentration of 20% was fed at a location upstream of the first adsorption bed 1A so that the pH of the treated solution fed to the first adsorption bed 1A was 6.85. After that, the sulfuric acid was fed continuously.

A pH meter (product name: D-73) and a pH electrode (product name: 9615-10D) manufactured by HORIBA, Ltd. were used to measure the above pH, and were installed as a pH measurement unit 4. As a reference electrode internal solution for this pH electrode, 3.33 mol/L-KCl solution (product name: 300) manufactured by HORIBA, Ltd. was used.

An aqueous sodium hypochlorite solution having an effective chlorine concentration of 6% was fed at a location upstream of the first adsorption bed 1A and downstream of the sulfuric acid feed point, so that the oxidation-reduction potential of the treated solution fed to the first adsorption bed 1A was 545 mV. After that, the sodium hypochlorite was fed continuously.

The aqueous sodium hypochlorite solution having an effective chlorine concentration of 6% was additionally fed at a location upstream of the second adsorption bed 1B and downstream of the first adsorption bed 1A, so that the oxidation-reduction potential of the treated solution fed to the second adsorption bed 1B was 555 mV. After that, the sodium hypochlorite was fed continuously.

The aqueous sodium hypochlorite solution having an effective chlorine concentration of 6% was additionally fed at a location upstream of the third adsorption bed 1C and downstream of the second adsorption bed 1B, so that the oxidation-reduction potential of the treated solution fed to the third adsorption bed 1C was 565 mV. After that, the sodium hypochlorite was fed continuously.

An ORP meter (model: D-73) and an ORP electrode (model: 9300-10D) manufactured by HORIBA, Ltd. were used to measure the above oxidation-reduction potential, and were installed as oxidation-reduction potential measurement units 51-53. As a reference electrode internal solution for this ORP electrode, 3.33 mol/L-KCl solution (model: 300) manufactured by HORIBA, Ltd. was used.

Every 4 hours, the concentration of iodine in the treated solution was determined at six locations: the inlet of the first adsorption bed 1A, the outlet of the first adsorption bed 1A, the inlet of the second adsorption bed 1B, the outlet of the second adsorption bed 1B, the inlet of the third adsorption bed 1C, and the outlet of the third adsorption bed 1C.

Ion chromatography instrument was used for the determination of the above iodine concentrations. The ion chromatography instrument was equipped with a column for anion analysis (product name: TSKgel IC-Anion-PW) manufactured by Tosoh Corporation, an eluent for anion analysis (product name: TSKgel eluent IC-Anion-A) manufactured by Tosoh Corporation, and a UV-VIS detector (product name: SPD-20A) manufactured by Shimadzu Corporation, and was installed as iodine concentration measurement units (61-66). In addition, the measurement wavelength of this UV-VIS detector was set to 230 nm.

### <Adsorption Switching A>

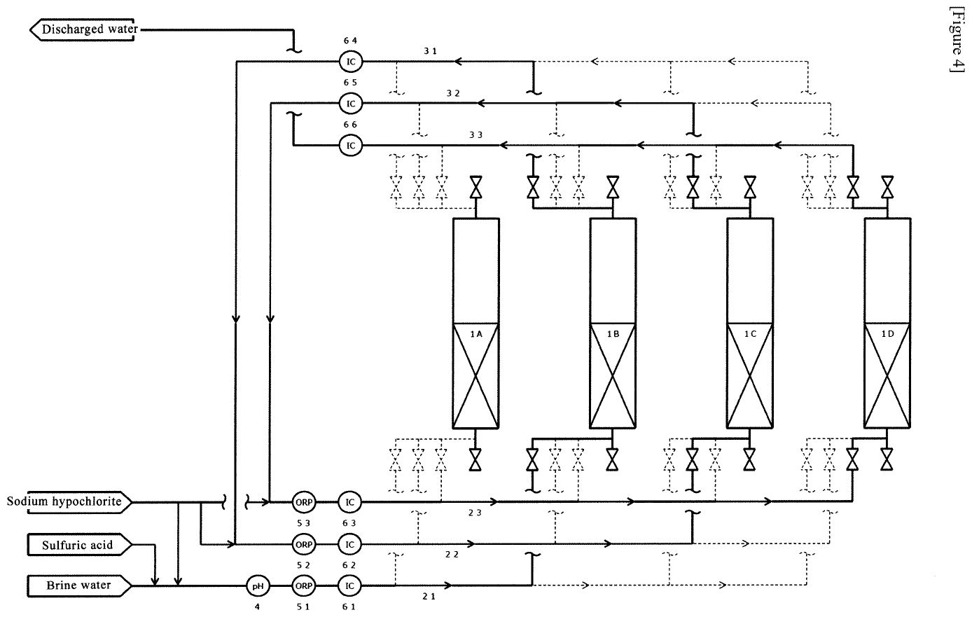

After 7 days (168 hours) from the start of “ABC adsorption”, the fourth adsorption bed 1D was loaded with 1.3 L of new ion-exchange resin without stopping the supply of brine water, the supply of sulfuric acid, the supply of sodium hypochlorite, and the determination of iodine concentration. As shown in FIG. 4, the adsorption beds were connected in the order of the second adsorption bed 1B, the third adsorption bed 1C, and the fourth adsorption bed 1D from the upstream end to the downstream end. Hereinafter, a case where the adsorption beds are connected in the order of the second adsorption bed 1B, the third adsorption bed 1C, and the fourth adsorption bed 1D to adsorb iodine in brine water on each adsorption bed is referred to as “BCD adsorption”. Switching from “ABC adsorption” to “BCD adsorption” is referred to as “adsorption switching A”. The ion-exchange resin that had adsorbed iodine was then removed from the first adsorption bed 1A to recover iodine.

### <Adsorption Switching B>

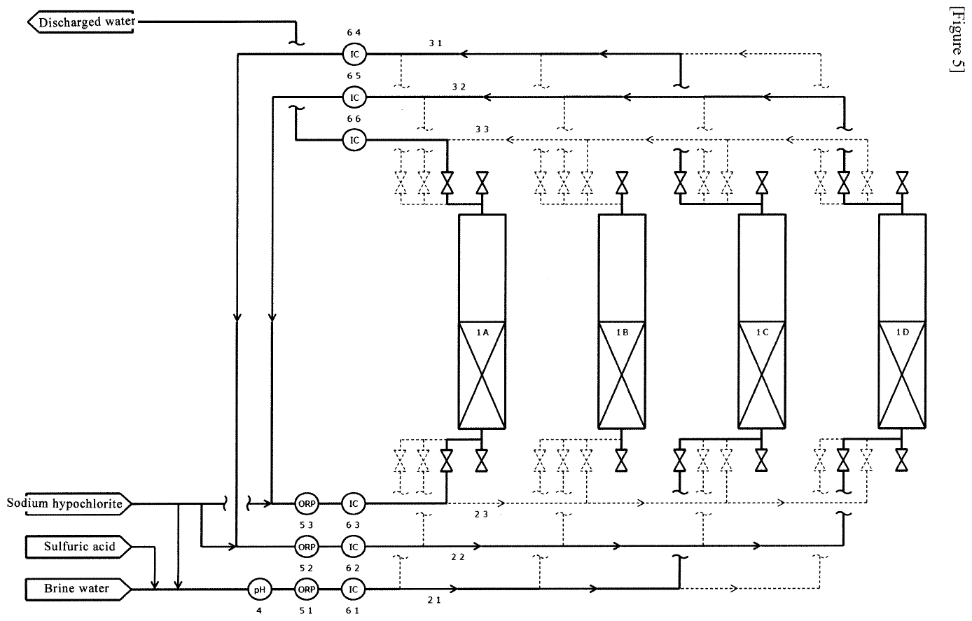

After 7 days (168 hours) from the start of “BCD adsorption”, the first adsorption bed 1A was loaded with 1.3 L of new ion-exchange resin without stopping the supply of brine water, the supply of sulfuric acid, the supply of sodium hypochlorite, and the determination of iodine concentration. As shown in FIG. 5, the adsorption beds were connected in the order of the third adsorption bed 1C, the fourth adsorption bed 1D, and the first adsorption bed 1A from the upstream end to the downstream end. Hereinafter, a case where the adsorption beds are connected in the order of the third adsorption bed 1C, the fourth adsorption bed 1D, and the first adsorption bed 1A to adsorb iodine in brine water on each adsorption bed is referred to as “CDA adsorption”. Switching from “BCD adsorption” to “CDA adsorption” is referred to as “adsorption switching B”. The ion-exchange resin that had adsorbed iodine was then removed from the second adsorption bed 1B to recover iodine.

### <Adsorption Switching C>

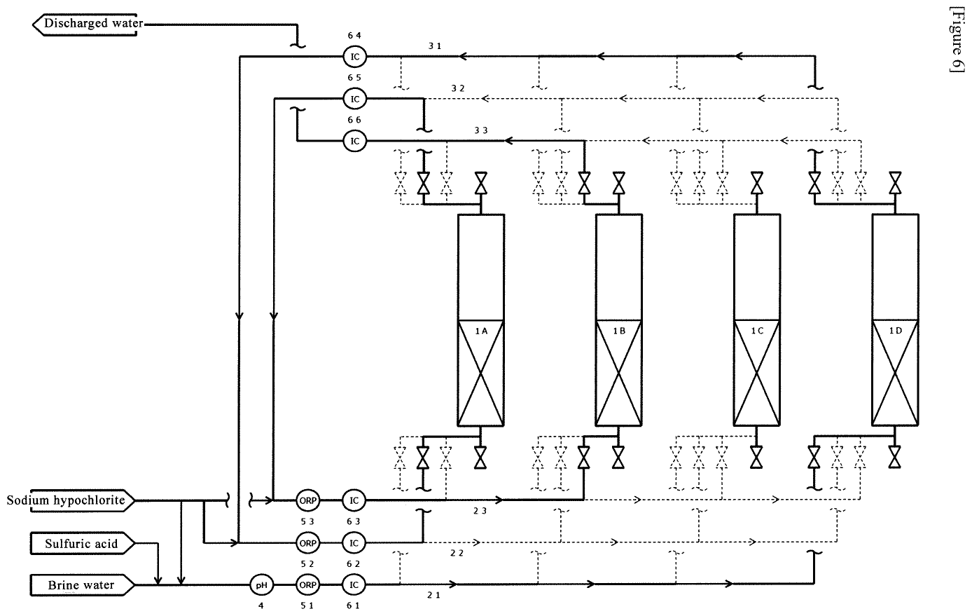

After 7 days (168 hours) from the start of “CDA adsorption”, the second adsorption bed 1B was loaded with 1.3 L of new ion-exchange resin without stopping the supply of brine water, the supply of sulfuric acid, the supply of sodium hypochlorite, and the determination of iodine concentration. As shown in FIG. 6, the adsorption beds were connected in the order of the fourth adsorption bed 1D, the first adsorption bed 1A, and the second adsorption bed 1B from the upstream end to the downstream end. Hereinafter, a case where the adsorption beds are connected in the order of the fourth adsorption bed 1D, the first adsorption bed 1A, and the second adsorption bed 1B to adsorb iodine in brine water on each adsorption bed is referred to as “DAB adsorption”. Switching from “CDA adsorption” to “DAB adsorption” is referred to as “adsorption switching C”. The ion-exchange resin that had adsorbed iodine was then removed from the third adsorption bed 1C to recover iodine.

### <Adsorption Switching D>

After 7 days (168 hours) from the start of “DAB adsorption”, the third adsorption bed 1C was loaded with 1.3 L of new ion-exchange resin without stopping the supply of brine water, the supply of sulfuric acid, the supply of sodium hypochlorite, and the determination of iodine concentration. As shown in FIG. 3, the adsorption beds were connected in the order of the first adsorption bed 1A, the second adsorption bed 1B, and the third adsorption bed 1C from the upstream end to the downstream end. Hereinafter, a case where the adsorption beds are connected in the order of the first adsorption bed 1A, the second adsorption bed 1B, and the third adsorption bed 1C to adsorb iodine in brine water on each adsorption bed is referred to as “ABC adsorption”. Switching from “DAB adsorption” to “ABC adsorption” is referred to as “adsorption switching D”. The ion-exchange resin that had absorbed iodine was then removed from the fourth adsorption bed 1D to recover iodine.

### <Test Results>

The above adsorption switching was performed every 7 days (168 hours) for a total of 8 times in the order of adsorption switching A, adsorption switching B, adsorption switching C, adsorption switching D, adsorption switching A, adsorption switching B, adsorption switching C, and adsorption switching D. For the last ABC adsorption, the amount of iodine adsorption in each adsorption bed was calculated by integrating the difference between the iodine concentrations at the inlet and outlet of each adsorption bed.

For the above ABC adsorption, the total volume of brine water fed during 7 days (168 hours) was 16,380 L, the iodine concentration of the brine water was 45.7 mg/L, and the iodine supply was 748.6 g. The amount of iodine adsorbed in the first adsorption bed 1A was 438.1 g, the amount of iodine adsorbed in the second adsorption bed 1B was 96.4 g, and the amount of iodine adsorbed in the third adsorption bed 1C was 51.6 g. The total amount of iodine adsorbed was 586.1 g and the total iodine recovery rate was 78.3%.

### Comparative Example 1

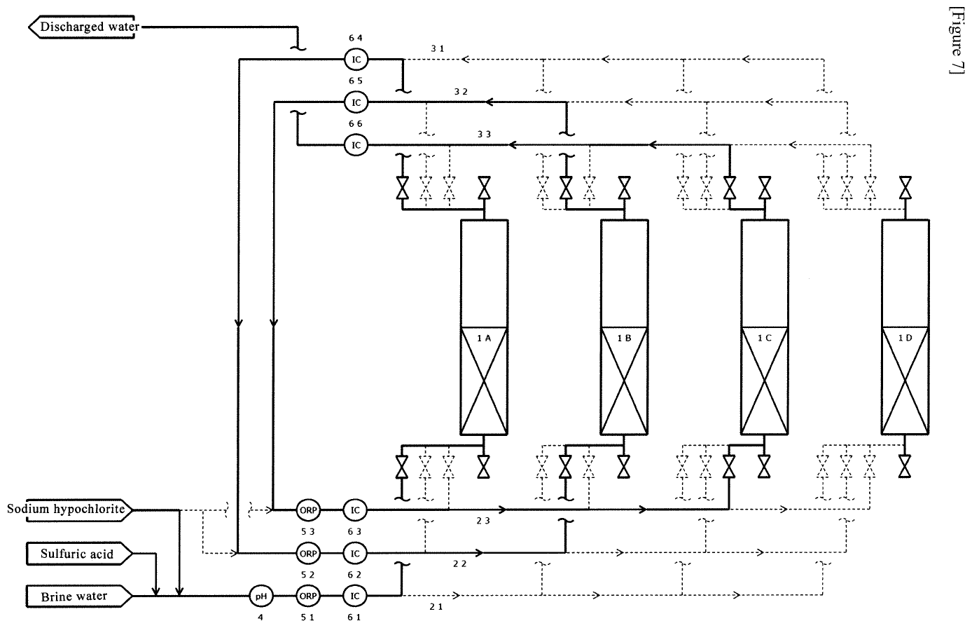

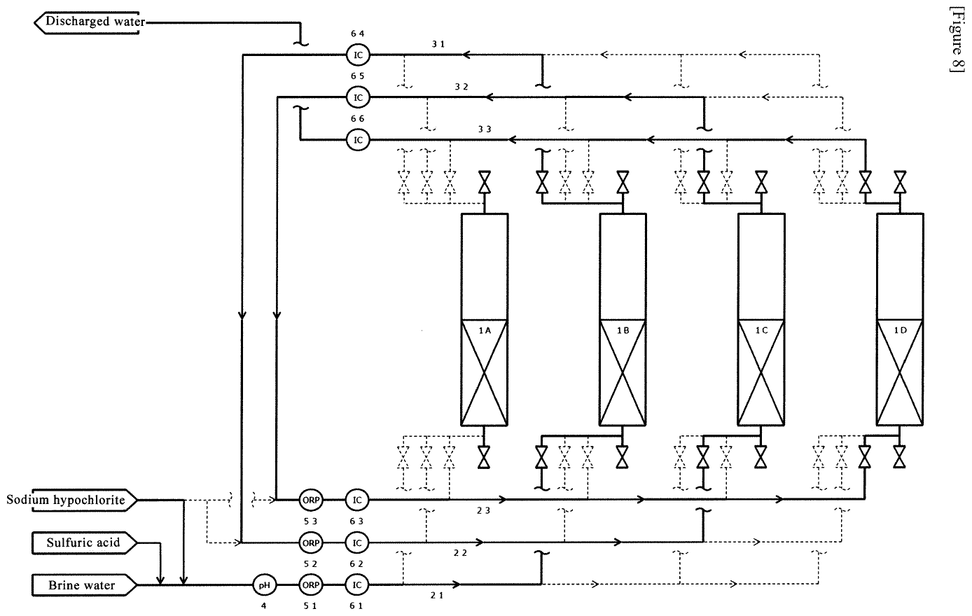

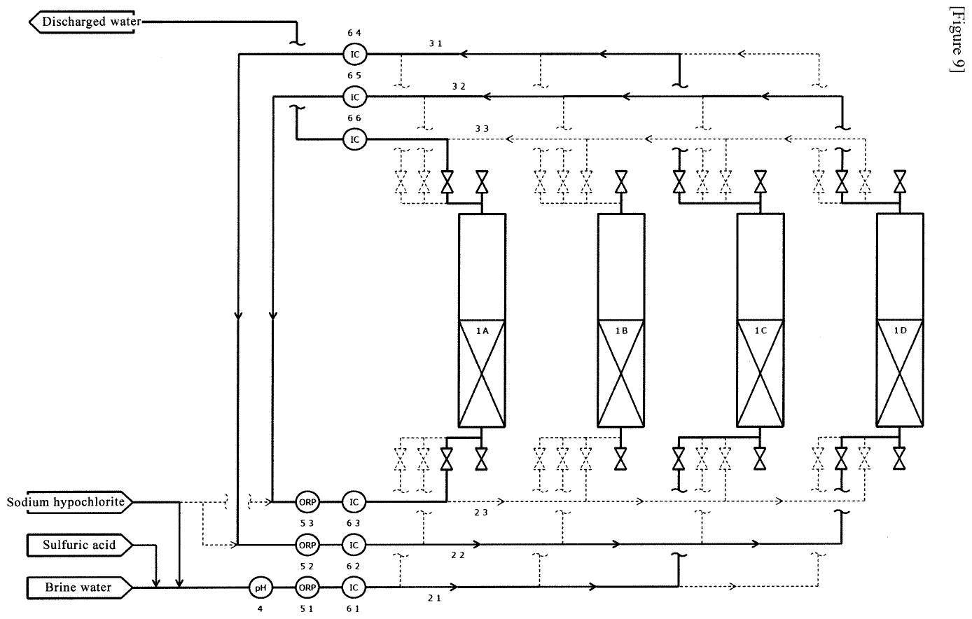

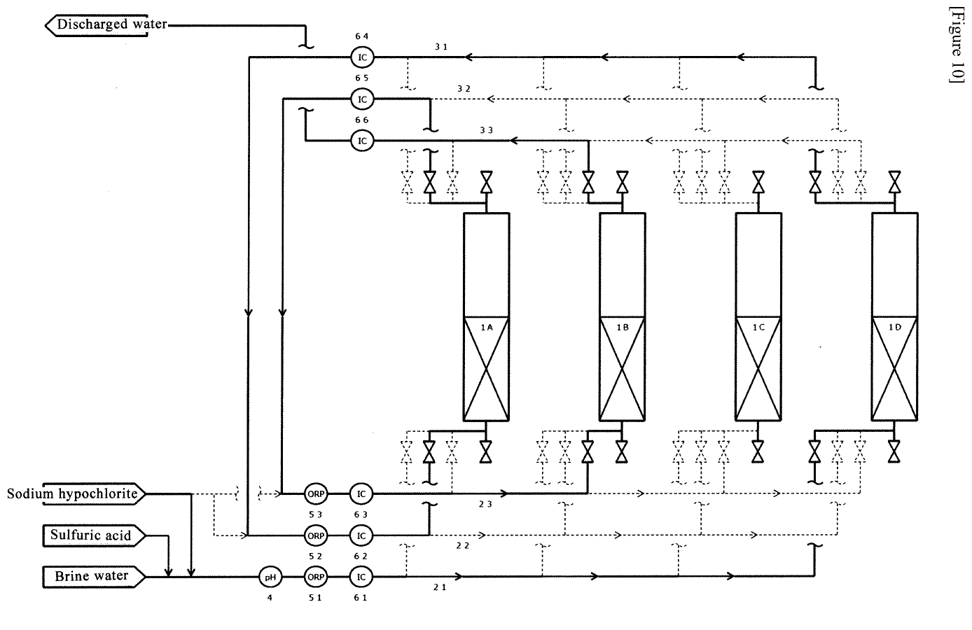

FIGS. 7-10 are schematic diagrams illustrating a method for adsorbing iodine in Comparative example 1.

### <Test Method>

In Comparative example 1, the same operations as in Example 1 were performed except that the aqueous sodium hypochlorite solution having an effective chlorine concentration of 6% was not fed at a location upstream of the second adsorption bed 1B and downstream of the first adsorption bed 1A, and that the aqueous sodium hypochlorite solution having an effective chlorine concentration of 6% was not fed at a location upstream of the third adsorption bed 1C and downstream of the second adsorption bed 1B.

### <Test Results>

In the same manner as in Example 1, the adsorption switching was performed every 7 days (168 hours) for a total of 8 times in the order of adsorption switching A, adsorption switching B, adsorption switching C, adsorption switching D, adsorption switching A, adsorption switching B, adsorption switching C, and adsorption switching D. For the last ABC adsorption, the amount of iodine adsorption in each adsorption bed was calculated by integrating the difference between the iodine concentrations at the inlet and outlet of each adsorption bed.

For the above ABC adsorption, the total volume of brine water fed during 7 days (168 hours) was 16,380 L, the iodine concentration of the brine water was 45.7 mg/L, and the iodine supply was 748.6 g. The amount of iodine adsorbed in the first adsorption bed 1A was 451.7 g, the amount of iodine adsorbed in the second adsorption bed 1B was 54.1 g, and the amount of iodine adsorbed in the third adsorption bed 1C was 3.1 g. The total amount of iodine adsorbed was 508.9 g and the total iodine recovery rate was 68.0%.

### REFERENCE SIGNS LIST

1A: First adsorption bed
1B: Second adsorption bed
1C: Third adsorption bed
1D: Fourth adsorption bed
21: Inlet piping for first adsorption bed
22: Inlet piping for second adsorption bed
23: Inlet piping for third adsorption bed
31: Outlet piping for first adsorption bed
32: Outlet piping for second adsorption bed
33: Outlet piping for third adsorption bed
4: pH measurement unit (pH)
51-53: Oxidation-reduction potential measurement unit (ORP)
61-66: Iodine concentration measurement unit (IC)

1. A method for adsorbing iodine using an adsorption apparatus that contains an adsorbent inside and that has two or more adsorption beds each having a feed port and a discharge port connected in series, the method comprising the steps of:
adding an oxidizing agent to an iodine-containing liquid and passing it through a first adsorption bed disposed at an upstream end; and
when passing the liquid that has passed through the first adsorption bed through one or more adsorption beds disposed downstream of the first adsorption bed, further adding an oxidizing agent before passing the liquid through any of the one or more adsorption beds.

2. The method according to claim 1, comprising the step of adding an acid to the iodine-containing liquid before or simultaneously with the addition of the oxidizing agent.

3. The method according to claim 2, wherein the acid is sulfuric acid.

4. The method according to claim 1, wherein a pH of the iodine-containing liquid before passing through the first adsorption bed is 5-7.5.

5. The method according to claim 1, wherein a pH of the iodine-containing liquid after the further addition of the oxidizing agent is 5-7.5.

6. The method according to claim 1, wherein a number of the adsorption beds is any of 3-5, and an oxidizing agent is further added before the iodine-containing liquid is passed through any of a third to fifth adsorption beds.

7. The method according to claim 1, wherein a number of the adsorption beds is any of 3-5, and an oxidizing agent is further added before the iodine-containing liquid is passed through each of a third to fifth adsorption beds.

8. The method according to claim 1, wherein the adsorption bed is a fluidized bed.

9. The method according to claim 1, wherein the adsorbent is a strongly basic ion-exchange resin.

10. The method according to claim 1, wherein the iodine-containing liquid is brine water associated with natural gas.

11. The method according to claim 1, wherein the oxidizing agent is chlorine or sodium hypochlorite.

12. The method according to claim 1, wherein an oxidation-reduction potential of the iodine-containing liquid before passing through the first adsorption bed is 500-600 mV.

13. The method according to claim 1, wherein an oxidation-reduction potential of the iodine-containing liquid after the further addition of the oxidizing agent is 500-600 mV.
